(19) United States
(12) Patent Application Publication
(10) Pub. No.: US 2005/0208201 A1
(43) Pub. Date: Sep. 22, 2005

(54) Method and apparatus for determining the concentrations of additives in a plating solution

(76) Inventors: Makoto Kubota, Yamato-shi (JP); Tsuyoshi Sahoda, Chigasaki-shi (JP); Tsutomu Nakada, Yokohama-shi (JP); Koji Mishima, Fujisawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/980,321

(22) Filed: Nov. 4, 2004

(30) Foreign Application Priority Data
Nov. 7, 2003 (JP) 2003-377952
Nov. 19, 2003 (JP) 2003-389604

(51) Int. Cl. B05D 1/00; B05C 11/00

(52) U.S. Cl. 427/8; 118/665

(57) ABSTRACT

This invention is a method of determining the concentration of any organic additive in a copper sulfate plating solution by using a cyclic voltammetric technique, comprising immersing a measuring probe in a copper sulfate plating solution not containing any organic additive and performing a plurality of times of potential sweeping prior to the analysis of any sample copper sulfate plating solution containing an organic additive. This invention is also a plating solution control system having a tank for preparing a plating solution, a station for determining the concentration of a surface active agent, a station for supplying a surface active agent and a control station, the station for determining the concentration of a surface active agent measuring the concentration of the surface active agent in a plating solution in the tank for preparing a plating solution.

### BACKGROUND OF THE INVENTION

This invention relates to a method and an apparatus for determining the concentrations of additives contained in a plating solution.

This invention also relates to a system for controlling the concentration of a surface active agent in a plating solution and more particularly to a system provided with a stalagmometer as a device for determining the concentration of the surface active agent. Moreover, this invention relates to a plating apparatus provided with such a system and a method of controlling a plating solution.

When the filling (plugging) of trenches and holes formed for wiring in the surface of a semiconductor substrate, etc. is carried out by copper sulfate electroplating, it is often the case that organic additives are added to copper sulfate (CuSO₄.5H₂O), sulfuric acid (H₂SO₄) and a chlorine ion (Cl⁻) forming the basic composition of a plating solution to improve the quality of a plating film and its ability to fill (plug) the trenches and holes.

The following three kinds of additives are generally used as the organic additives used in copper sulfate plating.

The first is a component called a carrier (or brightener) which makes a plating film dense and improves its luster. While various substances are known as the carriers, a sulfur compound (for example, mercaptoalkylsulfonic acid, HS-CₙH₂ₙ—SO₃) is generally used. This substance exists as an anion in a copper sulfate plating solution, prevents the precipitation of a copper ion and promotes its fine division.

The second is a component called a polymer (or suppressor or carrier) which is adsorbed to a cathode surface and suppresses the precipitation of a copper ion to enhance activation polarization and raise uniform electrodepositability. While various polymers are known as this component, a surface active agent, such as polyethylene glycol (PEG) or polypropylene glycol (PPG), is generally used.

The third is a component called a leveler and a nitrogen-containing compound, such as polyamine, can be mentioned as an example thereof. The leveler exists as a cation in a plating solution.

The adsorption of the leveler occurs in a large amount at a site of high current density and at the site where the adsorption of the leveler occurs in a large amount, an activation overvoltage increases and the precipitation of copper is suppressed. In a fine trench or at the bottom of a hole, on the other hand, the adsorption of the leveler decreases and the precipitation of copper occurs predominantly, resulting in a bottom-up state of precipitation. The plating solution which can achieve a bottom-up state of precipitation is considered as a plating solution of high leveling property.

Since the organic additives in a copper sulfate plating solution are a factor governing the quality of a plating film, its ability to fill holes, etc. as stated above, the control of their concentrations is very important.

Methods called a cyclic voltammetric (CV) method and a cyclic voltammteric stripping (CVS) method are known as methods used for controlling the concentrations of additives in a copper sulfate plating solution. These methods determine the amount of copper precipitated on a rotating cathode and obtain by conversion or calculation therefrom the concentrations of additives, such as a precipitation suppressor or accelerator. More specifically, the CVS analysis determines the polymer and leveler as the suppressors and the carrier as the accelerator.

It has, however, been difficult to say that even that method of analysis can analyze organic additives in a copper sulfate plating solution to a fully satisfactory extent. More specifically, while both the polymer and the leveler function to suppress the precipitation of copper as stated above, it has been a problem that the leveler has a very low suppressing effect as compared with the polymer and is unstable in its analytical value, since it is easily affected by external factors, such as the surface condition of a probe. Accordingly, there has been sought a device for analyzing the leveler more accurately.

In copper plating for a wiring circuit on a semiconductor substrate, it has been very important for obtaining a uniform plating layer to maintain constant the concentrations of these additives in a plating solution.

It is at present usual to use an electrode sensor as stated before in a method of determining the concentrations of these additives (Official Gazette JP-A-2003-253453). There are, however, cases in which the electrode sensors fail to make quick determination, depending on the additive component. There have been cases in which the determination by an electrode sensor of the concentration of a surface active agent used, among others, as an additive takes at least one hour and fails to respond quickly to any fluctuation in the concentration of the surface active agent.

### SUMMARY OF THE INVENTION

It is an object of this invention to provide a method which improves the accuracy in the determination of the concentrations of additives in a plating solution, typically a leveler, and an apparatus for determination used therefor.

It is another object of this invention to provide a plating solution control system having a determining device which can easily determine the concentration of a surface active agent in a plating solution and which is easy to maintain, and a plating apparatus having such a system and moreover, a method of controlling a plating solution.

As a result of our comprehensive study to solve the above objects, we, the inventors of this invention, have completed this invention by discovering that it is possible to determine the amount of a leveler in a copper sulfate plating solution accurately by conducting a plurality of times of potential sweeping in a copper sulfate plating solution not containing any organic additive component prior to the analysis of any sample.

Therefore, this invention is a method of determining the concentration of any organic additive in a copper sulfate plating solution by using a cyclic voltammetric technique, comprising immersing a measuring probe in a copper sulfate plating solution not containing any organic additive and performing a plurality of times of potential sweeping prior to the analysis of any sample copper sulfate plating solution containing an organic additive.

This invention is also an apparatus for determining the concentration of any organic additive in a copper sulfate plating solution which comprises a measuring probe having a working electrode, a reference electrode and a counter electrode, a base holding the probe vertically movably, a cell holder which moves from side to side or rotates with respect to the base and is capable of holding a plurality of cells, a device for introducing or discharging a liquid into or from each cell and a control unit for controlling them, wherein the control unit works to associate the vertical movement of the measuring probe and the movement or rotation of the cell holder, so that a copper sulfate plating solution containing any organic additive and a copper sulfate plating solution not containing any organic additive may be controlled for alternate introduction into the measuring cell in which the measuring probe is immersed.

We have also completed this invention by discovering that it is possible to solve the above object by using a stalagmometer as a method of determining the concentration of a surface active agent in a plating solution.

Therefore, this invention is a plating solution control system having a tank for preparing a plating solution, a station for determining the concentration of a surface active agent, a station for supplying a surface active agent and a control station, the station for determining the concentration of a surface active agent measuring the concentration of the surface active agent in a plating solution in the tank for preparing a plating solution, and in accordance with the result of the above measurement the station for supplying a surface active agent supplying a surface active agent to the tank for preparing a plating solution to control the concentration of the surface active agent in the plating solution to maintain it within a control concentration range, wherein the station for determining the concentration of a surface active agent has a stalagmometer.

This invention is also a plating apparatus for forming a metal plating film on a seed layer on a substrate surface which comprises a loading and unloading station, a substrate conveying device, a cleansing unit for cleansing a substrate, a plating device, a tank for preparing a plating solution and supplying it to the plating device, a station for determining the concentration of a surface active agent contained in the plating solution and a station for supplying a surface active agent, wherein the station for determining the concentration of a surface active agent determines it by a stalagmometer and in accordance with the result thereof the station for supplying a surface active agent adds the surface active agent to the plating solution to control the concentration of the surface active agent in the plating solution.

Moreover, this invention is a plating solution control method comprising measuring the concentration of a surface active agent in a plating solution by using a stalagmometer in a plating apparatus having a plating device, a tank for preparing a plating solution and supplying it to the plating device and a station for supplying a surface active agent, and in accordance with the result of the measurement, having a surface active agent added to the plating solution by the station for supplying a surface active agent.

This invention is also a plating solution control method comprising immersing a measuring probe in a copper sulfate plating solution not containing any organic additive and conducting a plurality of times of potential sweeping prior to measuring the concentration of any organic additive in a plating solution by using a cyclic voltammetric technique in a plating apparatus having a plating device, a tank for preparing a plating solution and supplying it to the plating device and a station for supplying any organic additive, followed by measuring the concentration of any organic additive, and in accordance with the result of the measurement, having any organic additive added to the plating solution by the station for supplying any organic additive.

Moreover, this invention is a plating solution control method as set forth above, wherein the station for supplying any organic additive adds any organic additive to the plating solution held in the tank for preparing a plating solution.

This invention is also a plating solution control apparatus comprising a tank for preparing a plating solution, a device for measuring the concentration of any organic additive as set forth in claim 3 and a station for supplying any organic additive, wherein the device for measuring the concentration of any organic additive determines the concentration of any organic additive in a plating solution and in accordance with the result thereof the station for supplying any organic additive supplies any organic additive to the plating solution.

Moreover, this invention is a plating apparatus for forming a metal plating film on a substrate surface which comprises a loading and unloading station, a substrate conveying device, a cleansing unit for cleansing a substrate, a plating device, a tank for preparing a plating solution and supplying it to the plating device, a station for determining the concentration of any organic additive contained in the plating solution and a station for supplying any organic additive, wherein the station for determining the concentration of any organic additive has a measuring probe and a plurality of cells capable of holding a basic solution or a sample plating solution.

By the method of this invention, it is possible to determine the concentration of any organic additive in a copper sulfate plating solution highly accurately. It is possible to determine, among others, the concentration of a leveler accurately which has hitherto been difficult.

The use of the plating solution control system, plating solution control method and plating apparatus of this invention makes it possible to determine the concentration of a surface active agent in a plating solution easily and reduce time and labor as required for the maintenance of any measuring device.

### BRIEF DESCRIPTION OF THE DRAWINGS

FIG. 1 is a diagram showing a system for carrying out a method of determining the concentration of any organic additive in a copper sulfate plating solution according to this invention.

FIG. 2 is a view outlining an example of apparatus used in accordance with this invention.

FIG. 3 is a view showing an example of the order of operation of the apparatus shown in FIG. 2.

FIG. 4 is a graph showing calibration curves as obtained in Example 1.

FIG. 5 is a set of sectional views showing an example of a plating process.

FIG. 6 is a diagram showing examples of a plating solution control system and a plating apparatus according to this invention.

FIG. 7 is a view showing an example of an analyzing station used in accordance with this invention.

FIG. 8 is a view showing another example of an analyzing station used in accordance with this invention.

FIG. 9 is a diagram showing an example of plating equipment used in accordance with this invention.

FIG. 10 is a diagram showing another example of plating equipment used in accordance with this invention.

FIG. 11 is a graph showing an example of a relation between the number of drops and the concentration of a surface active agent.

### DETAILED DESCRIPTION OF THE INVENTION

The method of this invention, which determines the amount of any organic additive in a copper sulfate plating solution by a CV or CVS technique using a measuring probe having a working electrode, a reference electrode and a counter electrode, is characterized by immersing the measuring probe in a copper sulfate plating solution not containing any organic additive and conducting a plurality of times of potential sweeping prior to measuring a sample copper sulfate plating solution containing any organic additive.

According to a method as hitherto employed, a copper sulfate plating solution not containing any organic additive (hereinafter referred to as a “basic solution”) is first analyzed by cyclic voltammetry, whereby a value of Ar0 is obtained, and organic additives to be measured are added one after another, whereby values of Ar1, Ar2, . . . and Arn are obtained one after another. A calibration curve is obtained from the relation between the amount of any organic additive added and the ratio of Arn/Ar0 and the amount of any organic additive in a plating solution to be analyzed is, then, measured. The measurements as stated above have been made successively and have not been intervened by any special treatment except cleansing.

According to the method of this invention, on the other hand, it is essential to immerse a probe in a basic solution and conduct a plurality of times of potential sweeping prior to each measurement.

This potential sweeping may be conducted under the same conditions as sweeping conducted in an actual CVS technique, etc. and the number of times of sweeping may be, say, 1 to 50.

As regards the measuring probe used by the method of this invention, it is possible to use one which has hitherto been used by a cyclic voltammetric technique. For example, it is possible to use as the measuring probe one formed by three electrodes, a working electrode (rotary disk electrode), a reference electrode 7 and a counter electrode 8 and it is possible to use a rotary platinum electrode, a carbon electrode, etc. as the working electrode, a mercury-mercury sulfate electrode, a silver-silver chloride electrode, etc. as the reference electrode and a copper electrode, a platinum electrode, etc. as the counter electrode.

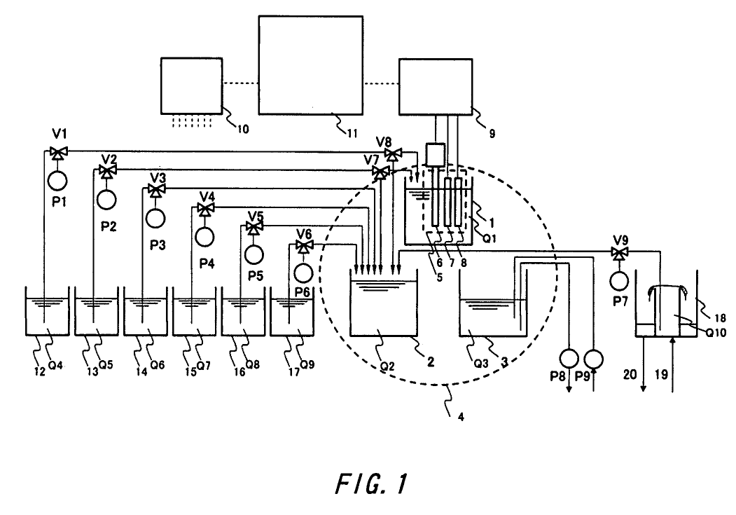

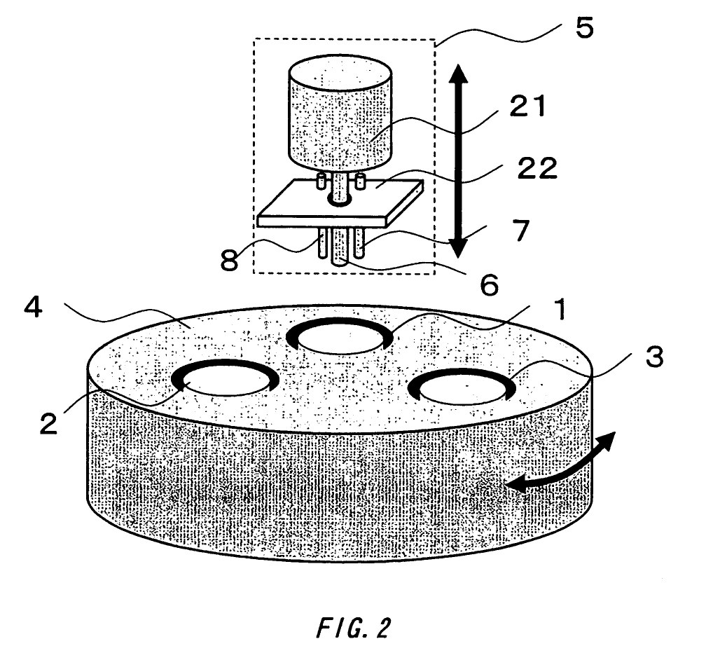

One form of apparatus for carrying out the method of this invention advantageously will now be described with reference to drawings. FIG. 1 is a diagram showing a system according to this invention for determining the concentration of any additive in a plating solution and FIG. 2 is a view outlining a device for determining the concentration of any additive. In the drawings, 1, 2 and 3 are cells into which a solution for analysis or a solution to be subjected to a plurality of times of potential sweeping (which solution is a sample plating solution, a calibration solution or a basic solution as will be described later, and will hereinafter be referred to as a “solution for electrolysis”) are distributed, and the cells are positioned in a rotary constant-temperature tank 4 and are movable.

In the drawings, 1, 2 and 3 are the cells, 1 is situated in a potential sweeping station (measurement), 2 is situated in a station for preparing a solution for electrolysis and 3 is situated in a waste solution discharging and water cleansing station. The cell 1 contains a solution Q1 for electrolysis, the cell 2 contains a solution Q2 prepared for electrolysis (hereinafter referred to as a “standby solution”) and the cell 3 contains a solution Q3 for electrolysis which has already been subjected to potential sweeping (hereinafter referred to as a “waste solution”).

A measuring probe 5 is formed by three electrodes, a working electrode (rotary disk electrode) 6, a reference electrode 7 and a counter electrode 8 and is immersed in the solution in the cell 1. The three electrodes are connected to a potentiogalvanostat 9, so that the electric current or potential to the working electrode 6 may be controlled, and voltammetry, typically cyclic voltammetry, is performed by positive or negative or arbitrary potential sweeping.

10 is a solution distributing unit which controls valves V1 to V9 and pumps P1 to P9 for, for example, introducing an organic additive solution and a basic solution into the cell 2 situated in a station for preparing a solution for analysis to prepare any necessary calibration solution, sampling a basic solution not containing any organic additive or a sample plating solution, or discharging an analyzed solution from the cell 3 after measurement and cleansing it. A control unit 11 is connected to the galvanostat 9 and the solution distributing unit 10 and controls the operation of the apparatus as a whole.

As the chemicals used for analysis, there are ready, for example, an additive B (carrier) Q4 held in a chemical tank 12, an additive C (leveler) Q5 held in a chemical tank 13, an additive A (polymer) Q6 held in a chemical tank 14, a calibration solution (polymer) Q7 held in a chemical tank 15, a basic solution 1 Q8 held in a chemical tank 16 and a basic solution 2 Q9 held in a chemical tank 17. The basic solutions Q8 and Q9 may differ from each other in the concentrations of components. Examples of the concentrations of components of a basic solution are shown below.

| | | |
|---|---|---|
| Copper sulfate pentahydrate | 150 to 250 | g/l |
| Sulfuric acid | 10 to 100 | g/l |
| Chlorine ion | 30 to 90 | mg/l |

Metering pumps P1, P2, P3, P4, P5 and P6 and three-way valves V1 V2, V3, V4, V5 and V6 are connected to the chemical tanks 12 to 17 holding those chemicals, respectively, to introduce any appropriate amount of each chemical into the cell 2. Moreover, V7 is connected to V2, and V8 to V1 to switch the introduction of chemicals from the cell 2 to the cell 1, as desired.

18 is a sample plating solution tank composed of an inner tank and an outer tank. A sample plating solution Q10 flows into the inner tank through a sample solution inlet 19, overflows into the outer tank and returns into a plating apparatus (not shown) through a sample solution return outlet. The plating solution in the inner tank can be introduced into the cell 2 by operating a valve V8 and a pump P7.

P8 is a pump for discharging a waste solution and P9 is a pump for supplying pure water. By operating these pumps, it is possible to discharge a waste solution left after measurement and cleanse the cell by repeating the supply of pure water and its discharge.

In FIG. 2, 21 is a rotary machine for rotating the working electrode and 22 is an electrode fixing jig.

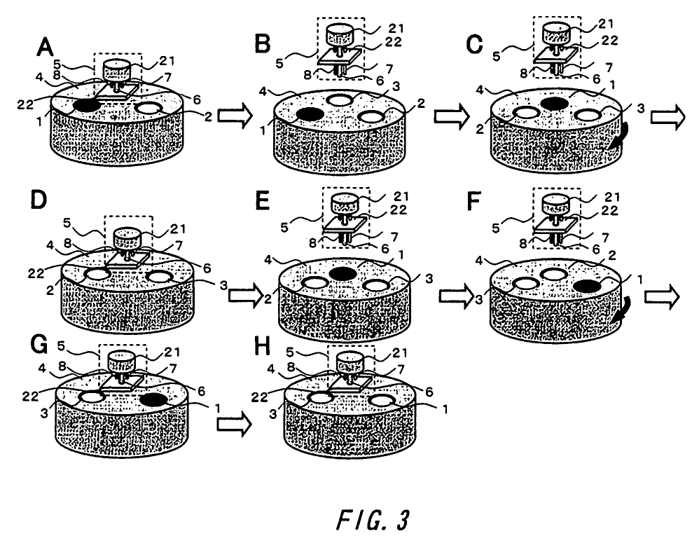

The basic actions of measurement according to this invention take place in the order of preparation of a solution for analysis, measurement, waste solution disposal and cleansing. A flow of the basic actions of analysis will be described with reference to FIG. 3.

A solution for electrolysis is first introduced into the cell 1, as shown at A of FIG. 3. On that occasion, the potential sweeping electrolysis of an older solution for electrolysis by the probe 5 is under way in the cell 3.

Then, the measuring probe 5 which has finished potential sweeping moves up and its working, reference and counter electrodes 6, 7 and 8 leave the cell 3, as shown at B of FIG. 3.

When the measuring probe 5 has moved up, the rotary constant-temperature tank 4 makes ⅓ of a revolution clockwise and the cell 1 into which a solution for electrolysis has been introduced moves to be situated immediately below the measuring probe 5, as shown at C of FIG. 3.

Then, the measuring probe 5 moves down and its working, reference and counter electrodes 6, 7 and 8 enter the solution for electrolysis in the cell 1, as shown at D of FIG. 3, whereby potential sweeping is performed and any necessary analysis or electrode cleansing is performed.

When potential sweeping has been finished in the solution for electrolysis in the cell 1, the measuring probe 5 which has finished potential sweeping moves up and its working, reference and counter electrodes 6, 7 and 8 leave the cell 1, as shown at E of FIG. 3.

Then, the rotary constant-temperature tank 4 makes another ⅓ of a revolution clockwise and the cell 2 into which a solution for electrolysis has been introduced moves to be situated immediately below the measuring probe 5 (F of FIG. 3), the measuring probe 5 moves down and the three electrodes enter the cell 2 for potential sweeping (G of FIG. 3), and when potential sweeping is being performed, the cell 1 is discharged with a waste solution and is further cleansed, for example (H of FIG. 3).

The basic actions of measurement can be performed smoothly by combining the vertical movement of the measuring probe 5 and the rotary motion of the rotary constant-temperature tank 4 as described, controlling their motions by the control unit 11 and also controlling the motions of the galvanostat 9 and the solution distributing unit 10 accordingly.

When the measurement of this invention is performed by using the apparatus described above, potential sweeping has to be performed alternately in the cell into which a solution for measurement (a sample plating solution or a calibration solution) has been introduced, and the cell into which a solution for cleansing the electrodes (a basic solution) has been introduced.

More specifically with reference to FIG. 3, when a sample plating solution is, for example, introduced into the cell 1, measurement has to be performed by introducing a basic solution into the cell 2, a calibration solution into the cell 3 and then a basic solution into the cell 1.

This makes possible a more accurate analysis of any organic additive by voltammetry.

The method of this invention makes it possible to determine the amount of a leveler in a copper sulfate plating solution more accurately than ever and control the plating solution more precisely.

When, for example, forming fine copper wiring on the surface of a semiconductor substrate, therefore, it is effective for realizing an improved yield, since it can decrease the formation of any reject.

Description will now be made of the plating solution control system, plating apparatus and plating solution control method according to this invention.

As to the surface active agent used in accordance with this invention, there is no particular limitation if it is commonly used as an additive to a plating solution, but it is possible to mention, for example, polyethylene glycol, polypropylene glycol, glycerol fatty acid ester, sorbitan fatty acid ester and propylene glycol fatty acid ester.

This invention will now be described in further detail with reference to the drawings, though these drawings are not intended for limiting the scope of this invention.

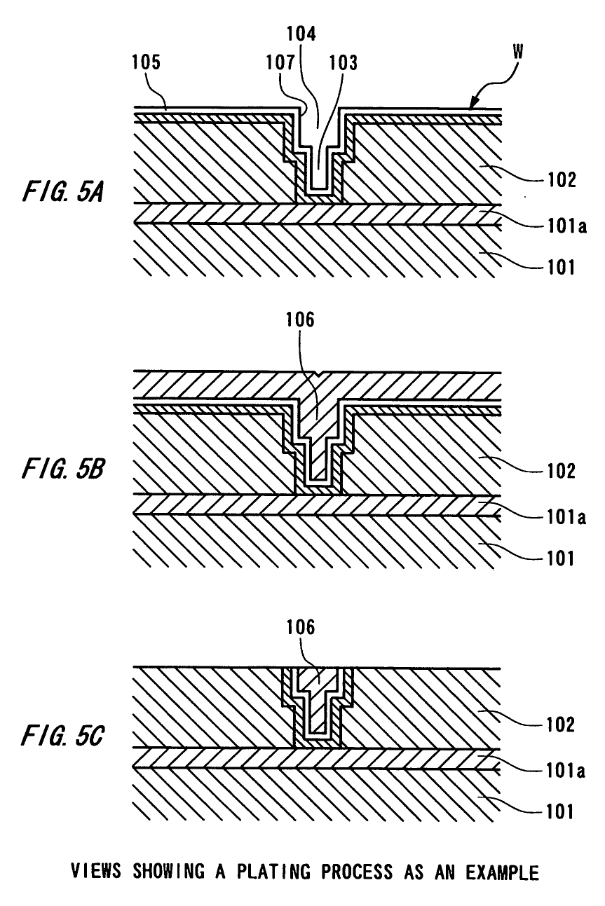

The plating solution control system and plating apparatus of this invention is mainly used for forming a copper layer of wiring by electrolytic copper plating on the plating surface of a semiconductor substrate. Description will first be made of an example of plating processes with reference to FIG. 5.

A semiconductor wafer W has a conductive layer 101a formed on a substrate 101 having a semiconductor device formed thereon, an insulating film 102 of SiO₂ deposited thereon, a contact hole 103 and a wiring trench 104 formed therein by lithography and etching, a barrier layer 105 formed thereon from e.g. TiN and a seed layer 107 formed thereon as a feed layer for electrolytic plating, as shown in FIG. 5(a).

The semiconductor wafer W has its surface plated with copper, so that a copper layer 106 may be deposited on the insulating film 102, while the contact hole 103 and trench 104 of the substrate 101 are filled with copper, as shown in FIG. 5(b). Then, the copper layer 106 on the insulating film 102 is removed by chemical mechanical polishing (CMP), so that the copper layer 106 filling the contact hole 103 and wiring trench 104 may have a surface substantially flush with the surface of the insulating film 102. As a result, wiring is formed by the copper layer 106, as shown in FIG. 5(c).

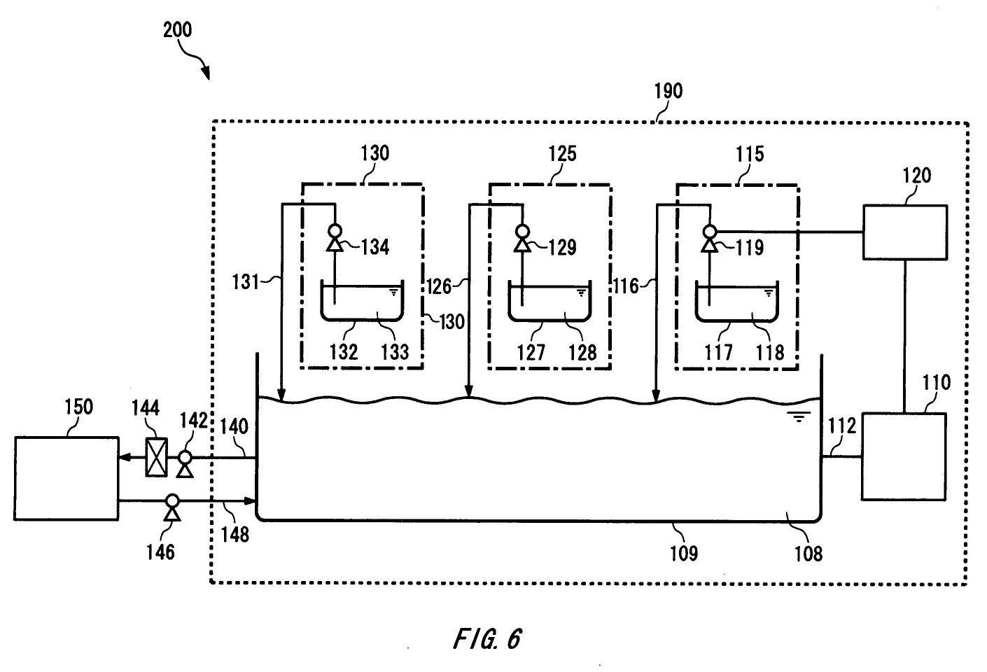

FIG. 6 is a diagram showing a plating solution control system 190 and a plating apparatus 200 according to this invention as examples. The plating solution control system 190 of this invention has a plating solution preparing tank 109 holding a plating solution 108, stations for supplying organic additives, such as a station 110 for determining the concentration of a surface active agent, a station 115 for supplying a surface active agent, a leveler supplying station 125 and a carrier supplying station 130 which are connected to the plating solution preparing tank 109 by pipelines 112, 116, 126 and 131, respectively, and a control station 120 connected to the station 110 for determining the concentration of a surface active agent and the station 115 for supplying a surface active agent, as shown in FIG. 6. The station 115 for supplying a surface active agent has a surface active agent tank 117 holding a surface active agent 118 and a pump 119 connected to the control station 120. The leveler supplying station 125 has a leveler tank 127 holding a leveler 128 and a pump 129 and the carrier supplying station 130 has a carrier tank 132 holding a carrier 133 and a pump 134.

The plating apparatus 200 of this invention has a plating station 150 connected to the plating solution preparing tank 109 in the plating solution control system 190 through a pipeline 140, a pump 142 and a filter 144 and a pipeline 148 and a pump 146, as shown in FIG. 6.

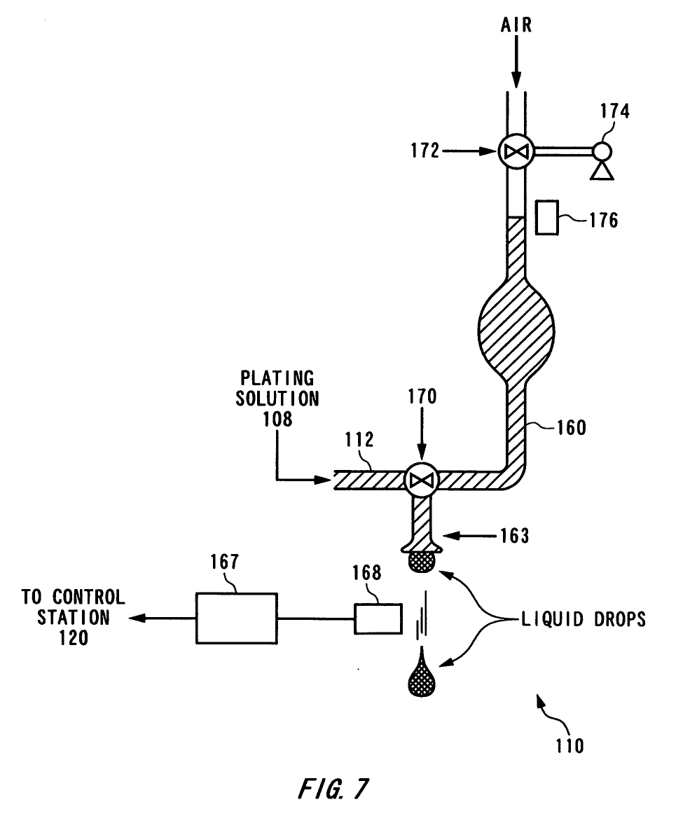

FIG. 7 is a front elevational view showing an example of station 110 for determining the concentration of a surface active agent. The station 110 for determining the concentration of a surface active agent which is used in accordance with this invention is composed of a stalagmometer 160, a suction pump 174 connected to the upper end of the stalagmometer 160 through a three-way valve 172, a liquid level sensor 176 situated above the stalagmometer 160, a drop number sensor 168 situated below the end 163 of the stalagmometer 160, a data analyzer 167 connected to the drop number sensor 168, a three-way valve 170 installed in the lower portion of the stalagmometer 160 and a pipeline 112 connected to the three-way valve 170, as shown in FIG. 7. A Traube stalagmometer as shown in FIG. 7 is preferably used as the stalagmometer. In the example of FIG. 7, the three-way valve 170 is installed in the lower portion of the Traube stalagmometer, as stated above.

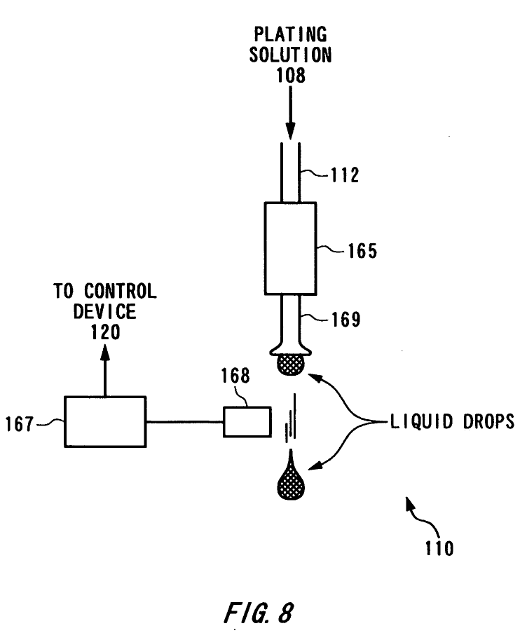

FIG. 8 is a front elevational view showing another example of station 110 for determining the concentration of a surface active agent. In this case, the station 110 for determining the concentration of a surface active agent is composed of a stalagmometer 169, a constant flow rate pump 165 connected to the upper end of the stalagmometer 169, a pipeline 112 connected to the constant flow rate pump 165, a drop number sensor 168 situated below the lower end of the stalagmometer 169 and a data analyzer 167 connected to the drop number sensor 168, as shown in FIG. 8.

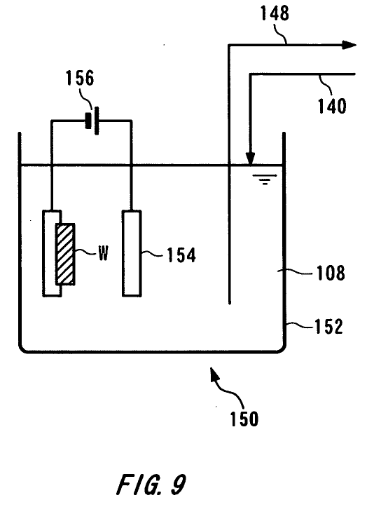

FIG. 9 is a sectional view showing one form of plating station 150 as an example. A plating tank 152 holds a plating solution 108 in which a wafer W mounted on a jig and an anode 154 are disposed opposite each other, while a power source 156 is connected between the wafer W and the anode and the plating tank 152 is connected to pipelines 140 and 148.

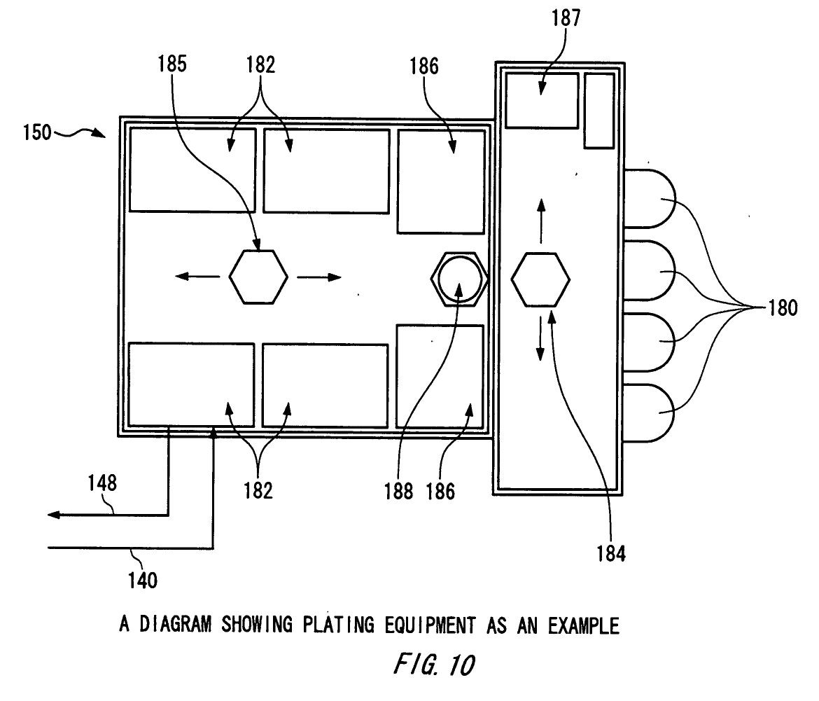

FIG. 10 is a top plan view showing another form of plating station 150 as a whole. The plating station 150 has four loading and unloading units 180 holding a plurality of wafers W therein, four plating units 182 for performing plating and auxiliary treatment, two conveying robots 184 and 185 for delivering and receiving the wafers W between the loading and unloading units 180 and the plating units 182, two bevel and rear surface cleansing units 186, a film thickness measuring device 187 and a temporary wafer support 188, as shown in FIG. 10. The plating units 182 are all connected to the pipelines 140 and 148, though they are only partly shown. In FIG. 10, the conveying robots 184 and 185 constitute a substrate conveying device according to this invention.

The plating solution control system and plating apparatus of this invention are constructed as described above and the operation thereof will now be described.

The plating solution 108 held in the plating solution preparing tank 109 is conveyed to the station 110 for determining the concentration of a surface active agent through the pipeline 112 and the number of drops in a given quantity of plating solution 108 is measured. The result of the measurement is transmitted to the data analyzer 167 and the concentration of the surface active agent in the plating solution 108 is obtained from the number of drops in accordance with a previously obtained reference table. Then, the value of the concentration of the surface active agent is transmitted to the control station 120 and when the concentration of the surface active agent is lower than the control concentration set therein, it is so controlled by the control station 120 that the surface active agent may supplied from the station 115 for supplying a surface active agent to restore a value within the range of control concentration.

The plating solution 108 having its concentration of a surface active agent controlled as described is delivered by the pump 142 through the pipeline 140 and the filter 144 into the plating station 150 and used for plating the wafer or wafers W in the plating tank 152 or plating units 182. The plating solution having its concentrations of a surface active agent, a carrier and a leveler lowered as a result of their consumption by plating is returned by the pump 146 into the plating solution preparing tank 109 through the pipeline 148.

Stations for determining the concentrations of organic additives, not shown, but including a station for determining the concentration of a carrier and a station for determining the concentration of a leveler, may be used to determine the concentrations of the carrier and leveler, so that the pump 134 in the carrier supplying station 130 and the pump 129 in the leveler supplying station 125 may be operated to supply the carrier and leveler, respectively, to maintain the carrier and leveler within the pre-set ranges of control concentrations.

Description will now be made in further detail of the operation of the station 110 for determining the concentration of a surface active agent. Referring to FIG. 7, the three-way valve 170 is operated to allow the plating solution 108 to flow into the stalagmometer 160 through the pipeline 112 and the three-way valve 172 is operated to cause the suction pump 174 to draw up the plating solution 108 into the stalagmometer 160. When the liquid level sensor 176 situated above the stalagmometer 160 has detected that a specific quantity of plating solution 108 has been drawn up, the three-way valves 170 and 172 are turned to their closed positions. Then, the three-way valve 170 is operated to allow the plating solution 108 drawn up into the stalagmometer 160 to flow toward its end 163 and the three-way valve 172 is operated to open to the air and allow the plating solution 108 to drop from the end 163 of the stalagmometer at a specific flow rate. The number of drops made by dropping a specific quantity of plating solution is determined by the drop number sensor 168 and the result of the determination is transmitted to the data analyzer 167. The concentration of the surface active agent in the plating solution 108 is obtained from the result of the determination on the number of drops in accordance with a reference table as obtained beforehand in the data analyzer 167. As to the drop number sensor 168, it is possible to use, for example, a photosensor placed opposite a source of light for detecting the shielding of light by each liquid drop passing therebetween and thereby determine the number of drops. As to the liquid level sensor 176, it is possible to use a mechanical, electrical or optical one or one relying upon ultrasonic waves for measurement. The quantity of the plating solution 108 to be drawn into the stalagmometer 160 and the flow rate at which it is dropped are determined appropriately depending on the properties of the surface active agent involved and it is necessary to ascertain beforehand the relation between the number of drops made by dropping a specific quantity of plating solution 108 and its concentration of the surface active agent as will be stated in Examples.

Referring to FIG. 8 showing another form of station 110 for determining the concentration of a surface active agent, a specific quantity of plating solution 108 is dropped from the stalagmometer 169 by operating the constant flow rate pump 165 through the pipeline 112. The number of its drops is determined by the drop number sensor 168 and the result of the determination is transmitted to the data analyzer 167. The concentration of the surface active agent in the plating solution 108 is obtained from the result of the determination on the number of drops in accordance with a reference table as obtained beforehand in the data analyzer 167. The rate at which the plating solution 108 is dropped and the quantity in which it is dropped are determined appropriately depending on the properties of the surface active agent involved and it is necessary to ascertain beforehand the relation between the number of drops made by dropping a specific quantity of plating solution 108 and its concentration of the surface active agent as will be stated in Examples.

Description will now be made of the operation of the plating station 150. Referring first to FIG. 9 showing one form of plating station 150, the plating solution 108 having its concentration of a surface active agent controlled is supplied into the plating tank 152 through the pipeline 140. A voltage is applied between the anode and the wafer W by the power source 156, whereby the wafer W has its surface plated with copper. After plating, the plating solution is returned into the plating solution preparing tank 109 through the pipeline 148.

Referring now to FIG. 10 showing another form of plating station 150, a wafer W to be plated is taken out by the conveying robot 184 from a wafer cassette installed in any of the loading and unloading stations 180 and is conveyed to the film thickness measuring device 187 in which the thickness of a plating film for the wafer W to be plated is determined. Then, the wafer W is taken out by the conveying robot 184 from the film thickness measuring device 187 and mounted on the temporary wafer support 188. Then, the wafer W on the temporary wafer support 188 is taken by the hands of the other conveying robot 185 and charged into any of the plating units 182 through its wafer charge and discharge opening, while its surface to be plated is held upside. The plating solution 108 having its concentration of a surface active agent controlled is supplied from the plating solution preparing tank 109 into the plating unit 188 through the pipeline 140 to plate the wafer. After plating, the plating solution is returned into the plating solution preparing tank 109 through the pipeline 148.

After its plating, the wafer W is discharged from the plating unit 185 by the conveying robot 185. The wafer W as discharged is conveyed to one of the bevel and rear surface cleansing units 186 and after its cleansing and drying, it is mounted on the temporary wafer support 188 by the conveying robot 185 and is, then, conveyed by the conveying robot 184 to the film thickness measuring device 187, in which the thickness of the plating film formed on the wafer W is measured, and it is conveyed by the conveying robot 184 into the wafer cassette installed in any of the loading and unloading stations 180. This is the end of the whole process of plating a single wafer W.

The plating apparatus of this invention may be so constructed that the plating solution control system 190 may be accommodated within the frame of the plating station shown in FIG. 10 to form an integral part thereof.

The invention will now be described in further detail by reference to examples, though this invention is not limited in any way by these examples.

### EXAMPLE 1

The method of determination according to this invention was carried out by using the apparatus as shown schematically in FIG. 3. A measuring probe having a mercury-mercury sulfate electrode as the reference electrode, a rotary platinum electrode as the working electrode and a copper electrode as the counter electrode was prepared and connected to a potentiogalvanostat.

On the other hand, the three cells, which had been ready with pure water introduced therein, were cleansed prior to the introduction of chemicals. Then, only cell 3 had pure water introduced therein. Cell 1 had 150 ml of a basic solution introduced therein, the constant-temperature tank was caused to make ⅓ (120°) of a revolution and the measuring probe was immersed.

The measuring probe was pre-treated by 10 times of alternate positive and negative sweeping with a potential of from −0.6 V to 1.1 V.

During the measurement, 46 ml of a basic solution having the composition shown below, 1 ml of additive A and 3 ml of additive B were introduced into another cell 2 to prepare a calibration solution having a leveler concentration of 0%. After its pre-treatment in cell 1, the probe was lifted, the constant-temperature tank was caused to make ⅓ of a revolution and the measuring probe was immersed in the 0% calibration solution in cell 2.

Concentrations of components of the basic solution:

| | | |
|---|---|---|
| Copper sulfate pentahydrate | 200 | g/l |
| Sulfuric acid | 50 | g/l |
| Chlorine ion | 50 | mg/l |

Then, 10 times of potential sweeping were performed under the same conditions as above and Ar0, which is the calibration point for a leveler concentration of 0%, was obtained from the stripping peak of the 10th sweeping.

After the measurement was over, the probe was lifted, the constant-temperature tank was caused to make ⅓ (120°) of a revolution, the calibration solution having a leveler concentration of 0% was discharged from cell 2 and the cell was emptied and cleansed. Then, the constant-temperature tank was caused to make ⅓ (120°) of a revolution again and 45 ml of basic solution 2, 1 ml of additive A, 3 ml of additive B and 1 ml of additive C were introduced into cell 2 to prepare a calibration solution having a leveler concentration of 50%. On the other hand, cell 3 was emptied of water and cleansed and water was introduced thereinto.

Then, the probe was lifted, the constant-temperature tank was caused to make ⅓ (120°) of a revolution, the measuring probe was immersed in cell 2 containing the calibration solution having a leveler concentration of 50%, 10 times of potential sweeping were performed under the same conditions as above and Ar1, which is the calibration point for a leveler concentration of 50%, was obtained from the stripping peak of the 10th sweeping.

There were likewise prepared a calibration solution having a leveler concentration of 100% from 44 ml of basic solution 2, 1 ml of additive A, 3 ml of additive B and 2 ml of additive C, a calibration solution having a leveler concentration of 150% from 43 ml of basic solution 2, 1 ml of additive A, 3 ml of additive B and 3 ml of additive C and a calibration solution having a leveler concentration of 200% from 42 ml of basic solution 2, 1 ml of additive A, 3 ml of additive B and 4 ml of additive C, potential sweeping was likewise performed, the stripping peaks were determined and Ar2, Ar3 and Ar4 were respectively obtained.

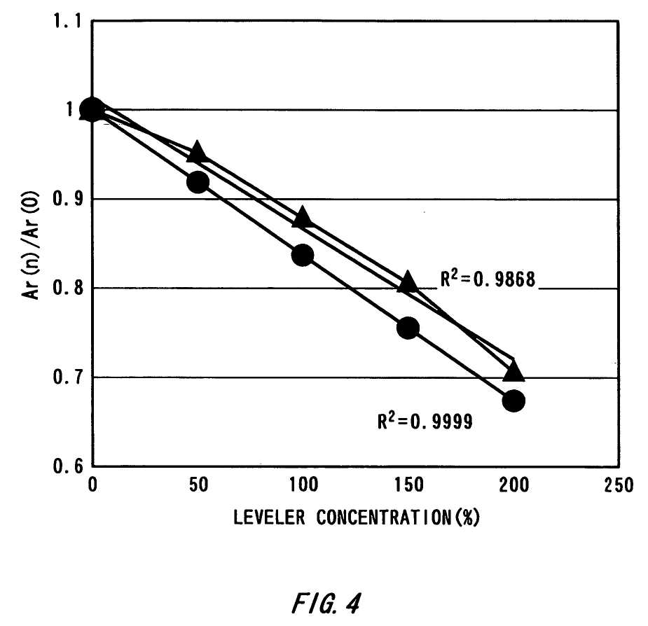

FIG. 4 shows a calibration curve prepared from the relation of the measured values Ar0 to Ar4 to the leveler concentration (shown as -*-). The Ar values were standardized by Ar0 (Ar0 to Ar4 divided by Ar). It also shows a calibration curve obtained without performing potential sweeping in the basic solution (shown as -▴-). The solution having a leveler concentration of 100% means a solution for analysis having the same composition with a solution for analysis as prepared from a copper plating solution containing a standard amount of a leveler component.

In the same way for any sample plating solution as above, 10 times of potential sweeping in a basic solution were followed by 10 times of potential sweeping in the sample solution and a measured value was obtained from the stripping peak of the 10th sweeping. The comparison of the measured value with the calibration curve obtained as described above gives the amount of the leveler in the sample solution.

### EXAMPLE 2

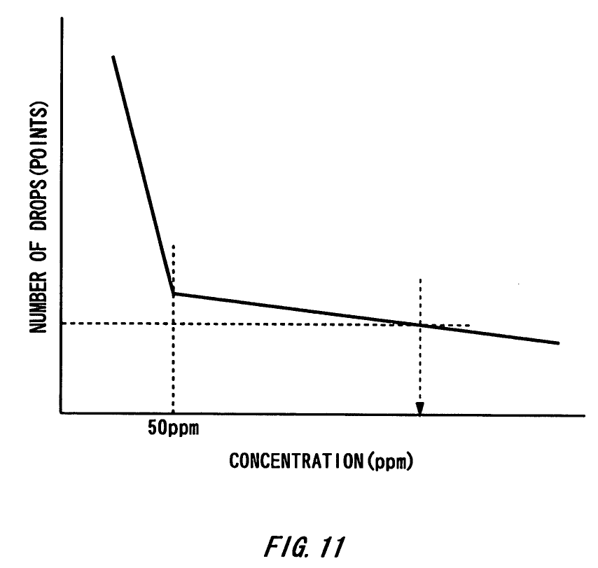

There are first prepared plating solutions having various concentrations of a surface active agent, such as 1, 5, 10, 50, 100 and 1000 ppm, and there is determined a relation between the number of drops made by dropping a specific quantity of each plating solution from a stalagmometer and its concentration of the surface active agent. There is obtained, for example, a result as shown in FIG. 11. In the case of FIG. 11, it is understood that there is a critical micelle concentration (cmc) in the vicinity of 50 ppm, and that the graph has its inclination change in the vicinity of cmc. These data are inputted to the data analyzer 167 as a reference table.

Then, the plating solution control system 190 shown in FIG. 6 may be employed to determine the concentration of the surface active agent in any plating solution of which the concentration of the surface active agent is sought to be determined. Its determination takes a time of, say, only one to 10 minutes, which is by far shorter than any determination hitherto made by an electrode sensor that has required at least one hour. The stalagmometer is not deteriorated by any plating solution, but is easy to maintain, since it is easier to cleanse than any electrode sensor hitherto employed.

1. A method of determining the concentration of any organic additive in a copper sulfate plating solution by using a cyclic voltammetric technique, comprising immersing a measuring probe in a copper sulfate plating solution not containing any organic additive and performing a plurality of times of potential sweeping prior to the analysis of any sample copper sulfate plating solution containing any organic additive.

2. The method of determining the concentration of any organic additive in a copper sulfate plating solution as set forth in claim 1, wherein the organic additive to be analyzed is a leveler.

3. An apparatus for determining the concentration of any organic additive in a copper sulfate plating solution which comprises a measuring probe having a working electrode, a reference electrode and a counter electrode, a base holding the probe vertically movably, a cell holder which moves from side to side or rotates with respect to the base and is capable of holding a plurality of cells, a device for introducing or discharging a liquid into or from each cell and a control unit for controlling them, wherein the control unit works to associate the vertical movement of the measuring probe and the movement or rotation of the cell holder, so that a copper sulfate plating solution containing any organic additive and a copper sulfate plating solution not containing any organic additive may be controlled for alternate introduction into the measuring cell in which the measuring probe is immersed.

4. The apparatus for determining the concentration of any organic additive in a copper sulfate plating solution as set forth in claim 3, wherein the cell holder is a rotary constant-temperature tank.

5. A plating solution control system having a tank for preparing a plating solution, a station for determining the concentration of a surface active agent, a station for supplying a surface active agent and a control station, the station for determining the concentration of a surface active agent measuring the concentration of the surface active agent in a plating solution in the tank for preparing a plating solution, and in accordance with the result of the above measurement the station for supplying a surface active agent supplying a surface active agent to the tank for preparing a plating solution to control the concentration of the surface active agent in the plating solution to maintain it within a control concentration range, wherein the station for determining the concentration of a surface active agent has a stalagmometer.

6. The plating solution control system as set forth in claim 5, wherein the stalagmometer is a Traube stalagmometer.

7. A plating apparatus for forming a metal plating film on a seed layer on a substrate surface which comprises a loading and unloading station, a substrate conveying device, a cleansing unit for cleansing a substrate, a plating device, a tank for preparing a plating solution and supplying it to the plating device, a station for determining the concentration of a surface active agent contained in the plating solution and a station for supplying a surface active agent, wherein the station for determining the concentration of a surface active agent determines it by a stalagmometer and in accordance with the result thereof the station for supplying a surface active agent adds the surface active agent to the plating solution to control the concentration of the surface active agent in the plating solution.

8. The plating apparatus as set forth in claim 7, wherein the stalagmometer is a Traube stalagmometer.

9. A plating solution control method comprising measuring the concentration of a surface active agent in a plating solution by using a stalagmometer in a plating apparatus having a plating device, a tank for preparing a plating solution and supplying it to the plating device and a station for supplying a surface active agent, and in accordance with the result of the measurement, having a surface active agent added to the plating solution by the station for supplying a surface active agent.

10. The plating solution control method as set forth in claim 9, wherein the stalagmometer is a Tranbe stalagmometer.

11. A plating solution control method comprising immersing a measuring probe in a copper sulfate plating solution not containing any organic additive and performing a plurality of times of potential sweeping prior to measuring the concentration of any organic additive in a plating solution by using a cyclic voltammetric technique in a plating apparatus having a plating device, a tank for preparing a plating solution and supplying it to the plating device and a station for supplying any organic additive, followed by measuring the concentration of any organic additive, and in accordance with the result of the measurement, having any organic additive added to the plating solution by the station for supplying any organic additive.

12. The plating solution control method as set forth in claim 11, wherein the station for supplying any organic additive adds any organic additive to the plating solution held in the tank for preparing a plating solution.

13. A plating solution control apparatus comprising a tank for preparing a plating solution, a device for measuring the concentration of any organic additive as set forth in claim 3 and a station for supplying any organic additive, wherein the device for measuring the concentration of any organic additive determines the concentration of any organic additive in a plating solution and in accordance with the result thereof the station for supplying any organic additive supplies any organic additive to the plating solution.

14. A plating apparatus for forming a metal plating film on a substrate surface which comprises a loading and unloading station, a substrate conveying device, a cleansing unit for cleansing a substrate, a plating device, a tank for preparing a plating solution and supplying it to the plating device, a station for determining the concentration of any organic additive contained in the plating solution and a station for supplying any organic additive, wherein the station for determining the concentration of any organic additive has a measuring probe and a plurality of cells capable of holding a basic solution or a sample plating solution.
